(19) United States
(12) Patent Application Publication
(10) Pub. No.: US 2006/0293083 A1
(43) Pub. Date: Dec. 28, 2006

(54) External phone book memory card and method of use

(75) Inventor: Patrick Bowen, San Diego, CA (US)

Correspondence Address: KYOCERA WIRELESS CORP., P.O. BOX 928289, SAN DIEGO, CA, 92192-8289, US

(73) Assignee: Kyocera Wireless Corp.

(21) Appl. No.: 11/142,878

(22) Filed: Jun. 1, 2005

(51) Int. Cl. H04B 1/38; H04M 1/00

(52) U.S. Cl. 455/558

(57) ABSTRACT

A method of using an external phone book memory card with a portable electronic device including an electronic address book with personal contact information, a memory card receiving slot, a memory card reader, and a display includes the steps of receiving an external phone book memory card in the memory card receiving slot, the external phone book memory card including phone book information stored thereon; reading the phone book information from the external phone book memory card with the memory card reader; and displaying the phone book information on the display.

### FIELD OF THE INVENTION

The present invention relates to portable electronic devices including electronic address books.

### BACKGROUND OF THE INVENTION

It is common for a wireless communication device (e.g., cell phone) to include an electronic address book or contacts application with the user's contacts (and their information) therein. To look up the information for a contact, the user activates the address book, and searches in the address book for the desired personal contact. A problem with these wireless communication device address books is that the information therein is limited to personal contacts, and does not include more general information such as, but not limited to, local restaurant info, local hotel info, and local business info. Thus, if a user wants to determine, for example, a phone number of a certain restaurant, the user has to go through the physical yellow/white pages, go through the online yellow/white pages, or call information (411). Not only is this time consuming and inconvenient, but in the case of calling information (411), the process can be costly, phone numbers are not saved, and no addresses are provided.

### SUMMARY

Thus, an aspect of the present invention relates to an external phone book memory card for a wireless communication device. The wireless communication device may include an integrated memory card reader that would interface with the mobile phones contacts list. The end user may receive a phone book for a local area on the memory card. The user's personal contacts remains on the device's internal memory. The user may subscribe/receive the equivalent of a community phone book on the memory card. The memory card may be updated by receiving a new card, similar to receiving a new phone book, or by updating the memory card over a network or using a PC or handset application to get the most recent information. This would be beneficial for users who travel, or users that want to have the phone book integrated with their wireless communication device and do not have or want to use the Internet option on their phone service. A user may purchase a new memory card with the local information on it from a vending machine, or point of sale at the travel destination.

Another aspect of the invention involves a method of using an external phone book memory card with a portable electronic device including an electronic address book with personal contact information, a memory card receiving slot, a memory card reader, and a display. The method includes the steps of receiving an external phone book memory card in the memory card receiving slot, the external phone book memory card including phone book information stored thereon; reading the phone book information from the external phone book memory card with the memory card reader; and displaying the phone book information on the display.

A further aspect of the invention involves a wireless communication device including an electronic address book with personal contact information. The wireless communication device includes a memory card receiving slot configured to receive an external phone book memory card including phone book information stored thereon; a memory card reader configured to read the phone book information from the external phone book memory card; and a display configured to display the phone book information.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a perspective view of an embodiment of a wireless communication device and an embodiment of an external phone book memory card for the wireless communication device.

FIG. 2 is a front elevational view of an embodiment of a display of the wireless communication device.

FIG. 3 is a high level network diagram illustrating an example system for updating the external phone book memory card for the wireless communication device and/or updating/adding a phone book to the internal memory of the wireless communication device.

FIG. 4 is an exemplary flow chart of a method of using an external phone book memory card with a portable electronic device including an electronic address book.

FIG. 5 is a block diagram illustrating an example wireless communication device as may be used in connection with various embodiments described herein; and

FIG. 6 is a block diagram illustrating an example computer system as may be used in connection with various embodiments described herein.

### DETAILED DESCRIPTION

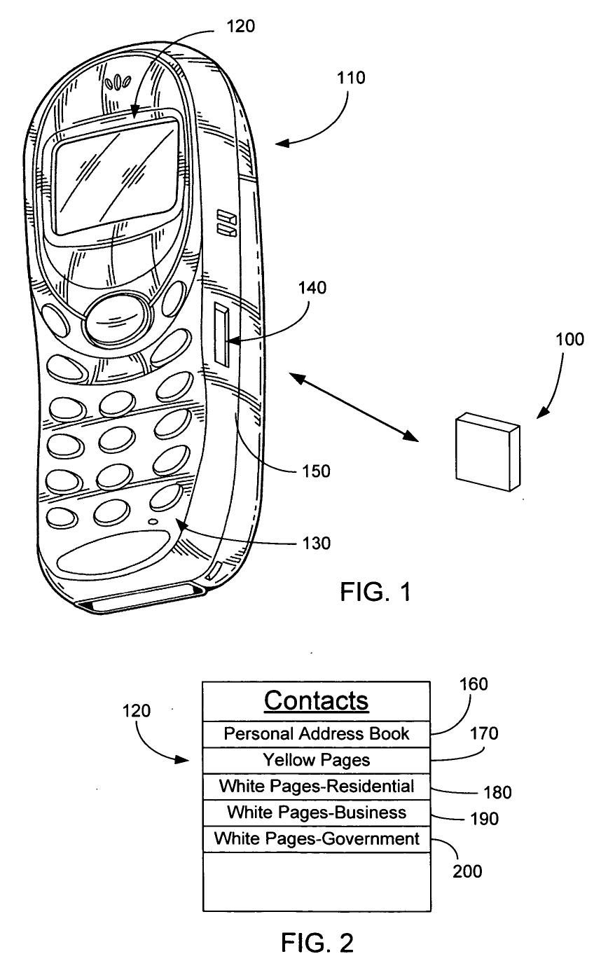

With reference to FIGS. 1-3, and initially to FIG. 1, an embodiment of an external phone book memory card 100 to be used with a wireless communication device 110 will now be described. Although the invention will be described in conjunction with a wireless communication device 110, the invention applies to any portable electronic device with an electronic address book. The wireless communication device 110 is illustrated as a cell phone; however, the wireless communication device may be PDA, a combination PDA/cell phone, or any other wireless communication device with an electronic address book. Although “phone book information” will generally be referred to below as including Yellow Pages information (i.e., business contact information by subject area) and White Pages information (business, residential, and government contact info by name and/or subject area), as used herein, “phone book information” includes all types of contact information, including Yellow Pages information, White Pages information, industry, group, or service information (e.g., contact information for a specific industry, group, or service), company information (e.g., contact information for a specific company), and government information (e.g., contact information for local, state, and/or federal government and military), just to name a few

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

The embodiment of the wireless communication device 110 shown in FIG. 1 includes a display screen 120, control keys 130, and a memory card receiving slot 140 on a side 150 of the wireless communication device 110. The receiving slot 140 slidingly receives the external phone book memory card 100.

The external phone book memory card 100 includes phone book information such as, but not limited to, white pages information and/or yellow pages information. Local business information such as, but not limited to, restaurants, bars, hotels, attractions, shopping, take-out food establishments, and taxi cab companies would be immediately available to the user. Phone numbers and/or address for listed individuals may be available through white pages-residential. The external phone book memory card 100 may be, for example, but not by way of limitation, a MultiMedia (MMC) Card, a Secure Digital (SD) Card, a FlashCard (FC).

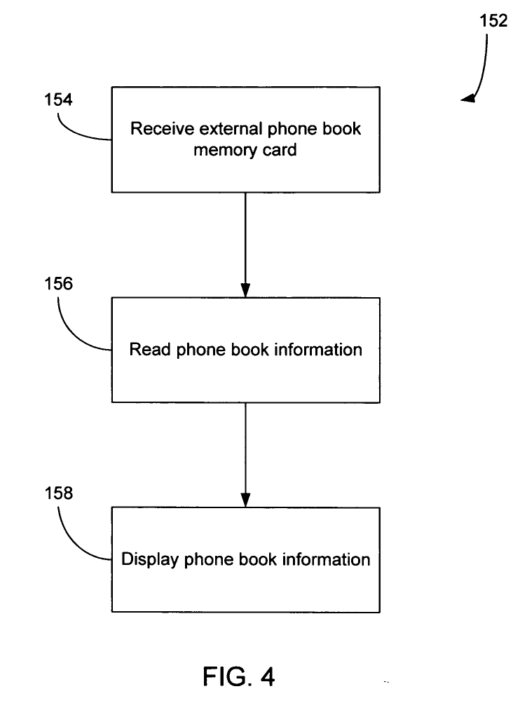

With reference additionally to FIG. 4, a method 152 of using the external phone book memory card 100 with the wireless communication device 110 will be described. At step 154, the external phone book memory card 100 is received in the memory card receiving slot 140. When the external phone book memory card 100 is fully received in the slot 140, and the user opens a “Contacts” application on the wireless communication device 110, at step 156, a memory card reader that is interfaced with a contacts list (e.g. address book) reads the memory on the external phone book memory card 100. The internal memory of the wireless communication device 110 is also read.

As shown, in FIG. 2, when “Contacts” are accessed, both the user's personal contacts (e.g., Personal Address Book) residing on the internal memory of the wireless communication device 110 as well as the phone book information (e.g., Yellow Pages, White Pages-Residential listings, White Pages-Business listings, and/or White Pages-Government listings) on the external phone book memory card 100 are read and may be accessed by the user. At step 158, Personal Address Book menu item 160, a Yellow Pages menu item 170, a White Pages-Residential menu item 180, a White Pages-Business menu item 190, and a White Pages-Government menu item 200 are displayed on the display screen 120 when “Contacts” are accessed on the wireless communication device 110 by the user. In an alternative embodiment, when a user opens “contacts”, individual phone book listings may be shown intermixed with the personal contacts (e.g., in alphabetical order).

When the user selects the Personal Address Book menu item 160, this selection is detected by the wireless communication device 110 and the user's personal contacts information on the internal memory of the wireless communication device 110 is read, and displayed on the display 120.

When the user selects the Yellow Pages menu item 170, this selection is detected by the wireless communication device 110 and Yellow Pages information on the external phone book memory card 100 is read. A search screen and/or subject matter index for accessing Yellow Pages information may be displayed. When the desired contact information is found, the user may select the desired contact information and be prompted to dial the phone number for the selected contact. Selection of the desired contact and the command to dial is detected by the wireless communication device 110, and the dialer dials the corresponding phone number. When the desired contact information is found, the user may select the desired contact information and be prompted to view the geographical location and/or obtain driving directions to the geographical location of the selected contact. Selection of the desired contact and the command to view the geographical location and/or obtain driving directions is detected by the wireless communication device 110, and the wireless communication device 110 includes a geographical mapping application that maps location data, and displays at least one of directions and geographical location on the display.

When the user selects the White Pages-Residential menu item 180, this selection is detected by the wireless communication device 110 and residential listing information on the external phone book memory card 100 is read. A search screen and/or index for accessing residential listing information may be displayed.

When the user selects the White Pages-Business menu item 190, this selection is detected by the wireless communication device 110 and business listing information on the external phone book memory card 100 is read. A search screen and/or index for accessing business listing information may be displayed.

When the user selects the White Pages-Government menu item 200, this selection is detected by the wireless communication device 110 and government listing information on the external phone book memory card 100 is read. A search screen and/or index for accessing government listing information may be displayed.

Although the external phone book memory card 100 is described as including Yellow Page listings, White Pages-Residential listings, White Pages-Business listings, and White Pages-Government listings, in alternative embodiments, the external phone book memory card 100 may include one or more of these listing types or other phone book information.

In the embodiment where the external phone book memory card 100 includes Yellow Pages/White Pages phone book information, each external phone book memory card 100 may correspond to single physical local phone book (e.g., local physical Yellow Pages phone book) a set of physical local phone books (e.g., local physical Yellow Pages, White Pages). Each external phone book memory card 100 may include a region (e.g., Southern California, California, United States) of phone books.

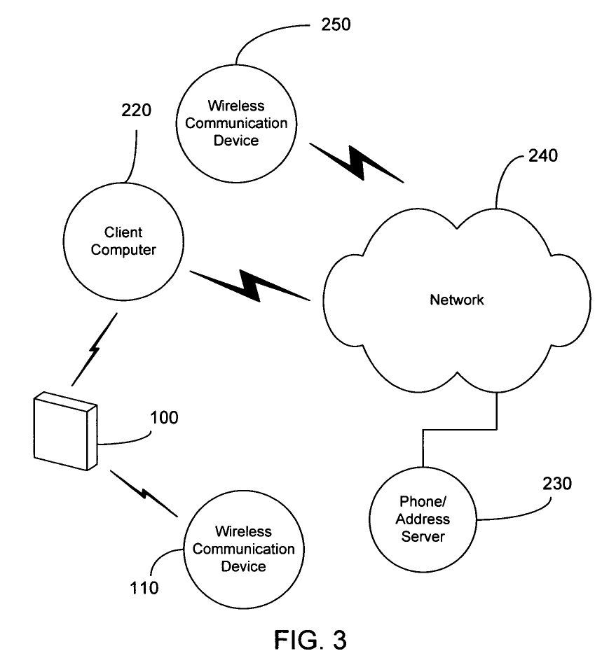

The user may subscribe/receive the equivalent of a community phone book on the external phone book memory card 100 in a manner similar to how telephone line subscribers receive hard copies of the Yellow Pages/White Pages, or the external phone book memory card 100 may come with the regular delivery of the local Yellow Pages/White Pages. The external phone book memory card 100 may be updated by receiving a new card, similar to receiving a new phone book, or by updating the external phone book memory card 100 using a PC or handset application or over the air, as will be described in more detail below with respect to FIG. 3, to get the most recent information. A user may purchase a new external phone book memory card 100 with the local information on it from a vending machine, or point of sale at the travel destination.

In an alternative embodiment of the phone book memory card 100, the card 100 has multiple separate phone books and access controls for the separate phone books on the card 100. The user may receive a specific code for access to one of the corresponding phone books on the card 100. A different code may give the user access to a different phone book on the card 100. Other codes may enable to the user to access multiple phone books on the card. The use may pay a one-time fee for access to the phone book(s) on the card 100, or may subscribe to a service and authorization to access the phone book(s) on the card 100 may be linked to the subscription.

In the embodiment of the external phone book memory card 100 and method described above, the external phone book memory card 100 is a read-only external phone book memory card 100. However, in an alternative embodiment, as will be described in more detail below with respect to FIG. 3, the external phone book memory card 100 may be readable and writable. In such an embodiment, for example, but not by way of limitation, the external phone book memory card 100 may be updated with current phone book information and/or, phone books for new areas may be added to the external phone book memory card 100.

With reference to FIG. 3, a high level network diagram illustrating an example system 210 for updating and/or adding phone book information to a readable/writable external phone book memory card 100 will be described. In the illustrated embodiment, a client computer 220 and a phone/address server 230 are separately communicatively coupled with communication network 240 (e.g., Internet). Although not illustrated for the sake of simplicity, there can be more than one client computer 220, more than one phone/address server 230, and more than one network 240. The one or more phone/address servers 230 may be run by, for example, but not by way of limitation, one or more specific companies (e.g., McDonalds, Motel 6), industries (e.g., hotel industry), destination organizations (e.g., local/regional chamber of commerce), and phone book providers (e.g., SBC, Ameritech).

To download phone book information to the external phone book memory card 100, a user may log onto an appropriate website on the Internet and select to download phone book information to the external phone book memory card 100. The external phone book memory card 100 may be connected to the computer through a memory card reading/writing device or via the wireless communication device (e.g., through a docking station or over the air). Phone book information may then be downloaded from the phone/address server 230 to the external phone book memory card 100 via the network 240 and the client computer 220. As indicated above, the phone book information downloaded to the external phone book memory card 100 may include, but not by way of limitation, current phone book information and/or one or more new phone books. The external phone book memory card 100 may then be used with the wireless communication device 110 to provide phone book information to the user in the manner described above.

As illustrated in FIG. 3, in an alternative embodiment, the phone book information may be downloaded to the internal memory of the wireless communication device 250 instead of downloading the phone book information to the external phone book memory card 100. In such an embodiment, the wireless communication device 250 may be connected to the phone/address server 230 through the network 240 (e.g., Internet) and the client computer 220 (e.g., via a docking station, data connection cable) to download phone book information to the internal memory of the wireless communication device 250.

Alternatively, the wireless communication device 250 may be wirelessly coupled to network 240 (e.g., wireless communication network), and phone book information from the phone/address server 230 may be downloaded wirelessly from the wireless communication network 240 to the memory or memory card 100 of the wireless communication device 250. For example, the wireless communication device 250 and an over-the-air connection may be used to update the external card 100. Thus, the user may update entries on the external card 100 based on updated information accessed over the air (via a wireless interface).

Regardless of whether the phone book information is downloaded to the external phone book memory card 100 or the internal memory of the wireless communication device 250, phone book information may be easily accessed by the user with the wireless communication device 110, 250 in the manner described above with respect to FIG. 2.

The user may have a subscription (e.g. Internet subscription) that authorizes the user to download phone book information to the external phone book memory card 100 or the memory of the wireless communication device 250 on a limited basis. Alternatively, the user may pay one fee for unlimited downloads. Either way, the user may easily update the external phone book memory card 100 or the internal memory with the latest phone book information, or may add new local/regional phone books for desired geographical areas to the external phone book memory card 100 or the internal memory.

In an alternative embodiment, the phone book information from the external phone book memory card 100 is downloaded to the internal memory of the communication device 250. Advantages to downloading the data from the card 100 to the device 150 include, but not by way of limitation, quicker access to the phone book information, eliminates the consequences of losing the card 100, and phone book information may be shared or downloaded to different devices of the user's.

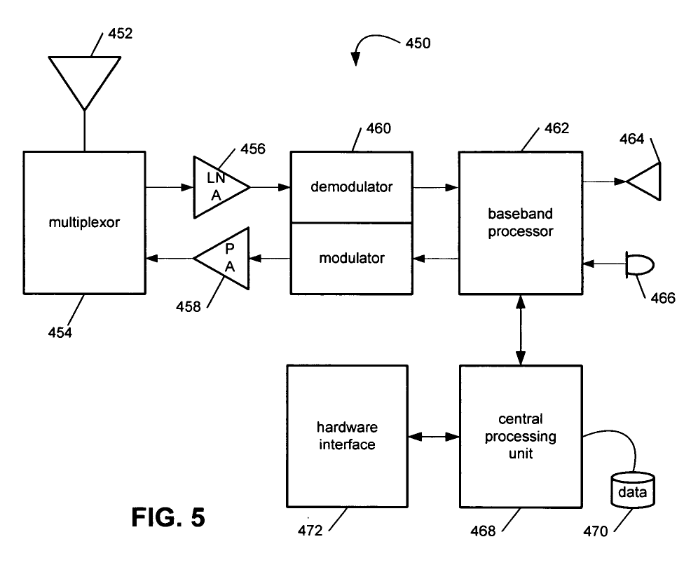

FIG. 5 is a block diagram illustrating an exemplary wireless communication device 450 that may be used in connection with the various embodiments (e.g., wireless communication device 110, 250) described herein. However, other wireless communication devices and/or architectures may also be used, as will be clear to those skilled in the art.

In the illustrated embodiment, wireless communication device 450 comprises an antenna 452, a multiplexor 454, a low noise amplifier (“LNA”) 456, a power amplifier (“PA”) 458, a modulation circuit 460, a baseband processor 462, a speaker 464, a microphone 466, a central processing unit (“CPU”) 468, a data storage area 470, and a hardware interface 472. In the wireless communication device 450, radio frequency (“RF”) signals are transmitted and received by antenna 452. Multiplexor 454 acts as a switch, coupling antenna 452 between the transmit and receive signal paths. In the receive path, received RF signals are coupled from a multiplexor 454 to LNA 456. LNA 456 amplifies the received RF signal and couples the amplified signal to a demodulation portion of the modulation circuit 460.

Typically modulation circuit 460 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 462.

If the base-band receive audio signal contains audio information, then base-band processor 462 decodes the signal and converts it to an analog signal. Then the signal is amplified and sent to the speaker 464. The base-band processor 462 also receives analog audio signals from the microphone 466. These analog audio signals are converted to digital signals and encoded by the base-band processor 462. The base-band processor 462 also codes the digital signals for transmission and generates a base-band transmit audio signal that is routed to the modulator portion of modulation circuit 460. The modulator mixes the base-band transmit audio signal with a RF carrier signal generating a RF transmit signal that is routed to the power amplifier 458. The power amplifier 458 amplifies the RF transmit signal and routes it to the multiplexor 454 where the signal is switched to the antenna port for transmission by antenna 452.

The baseband processor 462 is also communicatively coupled with the central processing unit 468. The central processing unit 468 has access to a data storage area 470. The central processing unit 468 is preferably configured to execute instructions (i.e., computer programs or software) that can be stored in the data storage area 470. Computer programs can also be received from the baseband processor 462 and stored in the data storage area 470 or executed upon receipt. Such computer programs, when executed, enable the wireless communication device 450 to perform the various functions of the present invention as previously described.

In this description, the term “computer readable medium” is used to refer to any media used to provide executable instructions (e.g., software and computer programs) to the wireless communication device 450 for execution by the central processing unit 468. Examples of these media include the data storage area 470, microphone 466 (via the baseband processor 462), antenna 452 (also via the baseband processor 462), and hardware interface 472. These computer readable mediums are means for providing executable code, programming instructions, and software to the wireless communication device 450. The executable code, programming instructions, and software, when executed by the central processing unit 468, preferably cause the central processing unit 468 to perform the inventive features and functions previously described herein.

The central processing unit is also preferably configured to receive notifications from the hardware interface 472 when new devices are detected by the hardware interface. Hardware interface 472 can be a combination electromechanical detector with controlling software that communicates with the CPU 468 and interacts with new devices.

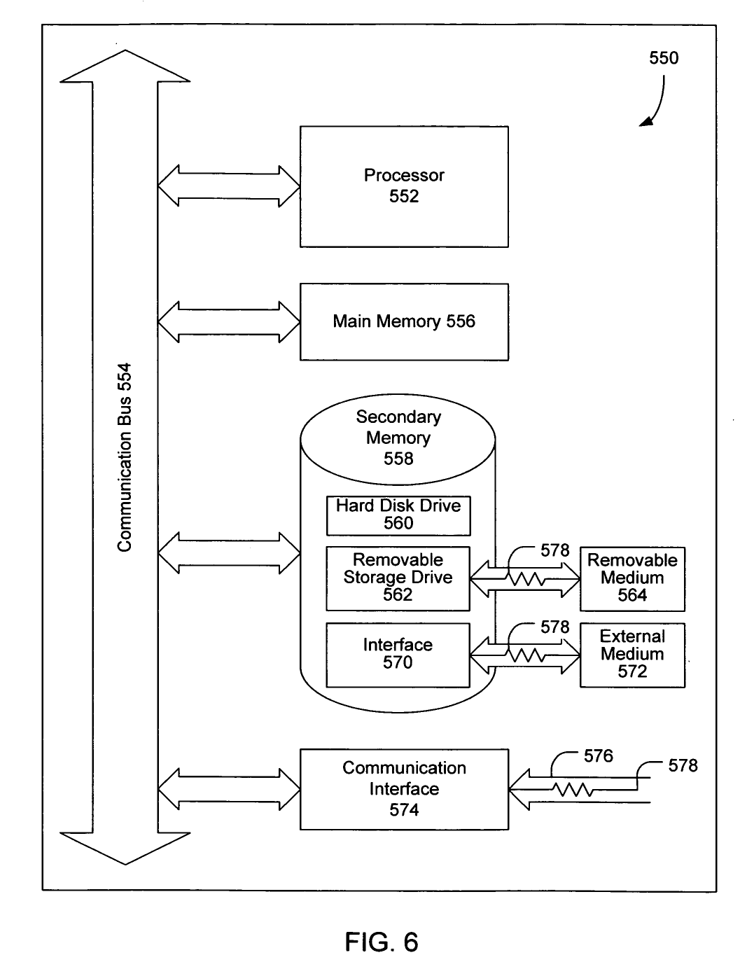

FIG. 6 is a block diagram illustrating an exemplary computer system 550 that may be used in connection with the various embodiments (e.g., client computer 220, phone/address server 230) described herein. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method of using an external phone book memory card with a portable electronic device including an electronic address book with personal contact information, a memory card receiving slot, a memory card reader, and a display, comprising:
receiving an external phone book memory card in the memory card receiving slot, the external phone book memory card including phone book information stored thereon;
reading the phone book information from the external phone book memory card with the memory card reader; and
displaying the phone book information on the display.

2. The method of claim 1, wherein the external phone book memory card is a memory card from the group consisting of a MultiMedia Card, a Secure Digital Card, a FlashCard.

3. The method of claim 1, wherein the portable electronic device is a wireless communication device.

4. The method of claim 1, wherein the portable electronic device includes internal memory with the personal contact information stored therein, and the method further includes reading the personal contact information from the internal memory.

5. The method of claim 4, further including displaying phone book information with personal contact information with the display.

6. The method of claim 1, further including displaying a personal contact menu item along with one or more phone book information menu items with the display.

7. The method of claim 6, further including detecting selection of the personal contact menu item or one or more phone book information menu items, reading the personal contact information from the internal memory if the personal contact menu item is selected, and reading phone book information from the external phone book memory card if the one or more phone book information menu items is selected.

8. The method of claim 1, wherein the phone book information is information from the group consisting of Yellow Pages information, White Pages information, industry contact information, group contact information, service industry contact information, company contact information, and government contact information.

9. The method of claim 1, wherein the portable electronic device includes a dialer, and the method further includes detecting selection of displayed phone book information, and dialing a corresponding phone number with the dialer.

10. The method of claim 1, wherein the portable electronic device includes a geographical mapping application, and method further includes detecting selection of displayed phone book information, mapping location data with the geographical mapping application, and displaying at least one of directions and geographical location with the display.

11. The method of claim 1, wherein the external phone book memory card is writable, and the method further includes at least one of updating and adding phone book information to the writable external phone book memory card.

12. The method of claim 1, wherein the portable electronic device includes internal memory, and the method further includes downloading phone book information from the external phone book memory card to the internal memory of the portable electronic device.

13. A wireless communication device including an electronic address book with personal contact information, comprising:
a memory card receiving slot configured to receive an external phone book memory card including phone book information stored thereon;
a memory card reader configured to read the phone book information from the external phone book memory card; and
a display configured to display the phone book information.

14. The wireless communication device of claim 13, wherein the external phone book memory card is a memory card from the group consisting of a MultiMedia Card, a Secure Digital Card, a FlashCard.

15. The wireless communication device of claim 13, wherein the wireless communication device includes internal memory with the personal contact information stored therein

16. The wireless communication device of claim 15, wherein the wireless communication device is configured to display phone book information with personal contact information on the display.

17. The wireless communication device of claim 15, wherein the wireless communication device is configured to display a personal contact menu item along with one or more phone book information menu items on the display.

18. The wireless communication device of claim 17, wherein the wireless communication device is configured to detect selection of the personal contact menu item or one or more phone book information menu items, read the personal contact information from the internal memory if the personal contact menu item is selected, and read the phone book information from the external phone book memory card if the one or more phone book information menu items is selected.

19. The wireless communication device of claim 13, wherein the phone book information is information from the group consisting of Yellow Pages information, White Pages information, industry contact information, group contact information, service industry contact information, company contact information, and government contact information.

20. The wireless communication device of claim 13, wherein the external phone book memory card is writable so that phone book information may be at least one of updated and added to the writable external phone book memory card.
